(19) United States
(12) Patent Application Publication
(10) Pub. No.: US 2022/0216604 A1
(43) Pub. Date: Jul. 7, 2022

(54) SMALL CELL ANTENNA INTEGRATED WITH STREET SIGN

(71) Applicant: CommScope Technologies LLC, Hickory, NC (US)

(72) Inventor: Peter J. Bisiules, LaGrange Park, IL (US)

(21) Appl. No.: 17/610,898

(22) PCT Filed: Jun. 10, 2020
(86) PCT No.: PCT/US2020/036937

§ 371 Date: Nov. 12, 2021

Related U.S. Application Data
(60) Provisional application No. 62/861,491, filed on Jun. 14, 2019.

(51) Int. Cl. H01Q 1/44; H01Q 21/28; H01Q 25/00; H01Q 9/04; H01Q 1/42; H01Q 21/06; H01Q 21/08

(52) U.S. Cl. CPC H01Q 1/44; H01Q 21/28; H01Q 25/005; H01Q 21/08; H01Q 1/42; H01Q 21/065; H01Q 9/0407

(57) ABSTRACT

A small cell base station includes: (a) an antenna including: a ground plane; a plurality of radiating elements mounted to the ground plane; a feed network connected with the plurality of radiating elements; and a cover that overlies the radiating elements, the cover including visual indicia that provides traffic information to motorists; and (b) a radio connected with the feed network.

### RELATED APPLICATION

The present application claims the benefit of and priority from U.S. Provisional Patent Application No. 62/861,491, filed Jun. 14, 2019, the disclosure of which is hereby incorporated herein in its entirety.

### FIELD OF THE INVENTION

Aspects of the present disclosure relate to cellular communications systems, including distributed antenna systems, communications systems that include small cell radio base stations, and communication systems that include macrocell radio base stations.

### BACKGROUND

Cellular communications systems are well known in the art. In a typical cellular communications system, a geographic area may be divided into a series of regions that are referred to as “cells,” and each cell is served by a base station. Typically, a cell may serve users who are within a distance of, for example, 2-20 kilometers from the base station, although smaller cells are typically used in urban areas to increase capacity. The base station may include baseband equipment, radios and antennas that are configured to provide two-way radio frequency (“RE”) communications with mobile subscribers that are positioned throughout the cell. In many cases, the cell may be divided into a plurality of “sectors,” and separate antennas may provide coverage to each of the sectors. The antennas are often mounted on a tower or other raised structure, with the radiation beam (“antenna beam”) that is generated by each antenna directed outwardly to serve a respective sector. Typically, a base station antenna includes one or more phase-controlled arrays of radiating elements, with the radiating elements arranged in one or more vertical columns when the antenna is mounted for use. Herein, “vertical” refers to a direction that is perpendicular relative to the plane defined by the horizon.

In order to increase capacity, cellular operators have, in recent years, been deploying so-called “small cell” cellular base stations. A small cell base station refers to a low-power base station that may operate in the licensed and/or unlicensed spectrum that has a much smaller range than a typical “macrocell” base station. A small cell base station may be designed to serve users who are within short distances from the small cell base station (e.g., tens or hundreds of meters). Small cells may be used, for example, to provide cellular coverage to high traffic areas within a macrocell, which allows the macrocell base station to offload much or all of the traffic in the vicinity of the small cell to the small cell base station. Small cells may be particularly effective in Long Term Evolution (“LTE”) cellular networks in efficiently using the available frequency spectrum to maximize network capacity at a reasonable cost. Small cell base stations typically employ an antenna that provides full 360 degree coverage in the azimuth plane and a suitable beamwidth in the elevation plane to cover the designed area of the small cell. In many cases, the small cell antenna will be designed to have a small downtilt in the elevation plane to reduce spill-over of the antenna beam of the small cell antenna into regions that are outside the small cell and also for reducing interference between the small cell and the overlaid macro cell.

FIG. 1 is a schematic diagram of a conventional small cell base station 10. As shown in FIG. 1, the base station 10 includes an antenna 20 that may be mounted on a raised structure 30. The antenna 20 may have an omnidirectional antenna pattern in the azimuth plane, meaning that the antenna beam(s) generated by the antenna 20 may extend through a full 360 degree circle in the azimuth plane.

As is further shown in FIG. 1, the small cell base station 10 also includes base station equipment such as baseband units 40 and radios 42. A single baseband unit 40 and a single radio 42 are shown in FIG. 1 to simplify the drawing. Additionally, while the radio 42 is shown as being co-located with the baseband equipment 40 at the bottom of the antenna tower 30, it will be appreciated that in other cases the radio 42 may be a remote radio head that is mounted on the antenna tower 30 adjacent the antenna 20. The baseband unit 40 may receive data from another source such as, for example, a backhaul network (not shown) and may process this data and provide a data stream to the radio 42. The radio 42 may generate RF signals that include the data encoded therein and may amplify and deliver these RF signals to the antenna 20 for transmission via a cabling connection 44. The base station 10 of FIG. 1 will typically include various other equipment (not shown) such as, for example, a power supply, back-up batteries, a power bus and the like.

It may be desirable to provide small cell antennas in different environments that capitalize on the presence of current structures.

### SUMMARY

As a first aspect, embodiments of the invention are directed to a small cell base station comprising an antenna and a radio. The antenna comprises: a ground plane; a plurality of radiating elements mounted to the ground plane; a feed network connected with the plurality of radiating elements; and a cover that overlies the radiating elements, the cover including visual indicia that provides traffic information to motorists. The radio is connected with the feed network.

As a second aspect, embodiments of the invention are directed to a small cell antenna comprising: a ground plane; a plurality of radiating elements mounted to the ground plane; a feed network connected with the plurality of radiating elements; and a cover that overlies the radiating elements, the cover including visual indicia that provides traffic information to motorists.

As a third aspect, embodiments of the invention are directed to a small cell antenna comprising a ground plane having opposed front and rear surfaces; first and second pluralities of radiating elements mounted to the ground plane, the first plurality of radiating elements having a different operating frequency from the second plurality of radiating elements; a feed network connected with the pluralities of radiating elements; and a cover that overlies the radiating elements, the cover including visual indicia that provides traffic information to motorists. Some of the first plurality of radiating elements are mounted on the front surface of the ground plane, and the remaining radiating elements of the first plurality are mounted on the rear surface of the ground plane. Some of the second plurality of radiating elements are mounted on the front surface of the ground plane, and the remaining radiating elements of the second plurality are mounted on the rear surface of the ground plane.

As a fourth aspect, embodiments of the invention are directed to a small cell antenna comprising: a ground plane; a plurality of radiating elements that form part of the ground plane; a feed network connected with the plurality of radiating elements; and a cover that overlies the radiating elements, the cover including visual indicia that provides traffic information to motorists.

### BRIEF DESCRIPTION OF THE FIGURES

FIG. 1 is a simplified schematic diagram illustrating a conventional small cell cellular base station.

FIG. 2 is a perspective view of a street sign antenna according to embodiments of the invention.

FIG. 3 is a schematic view of the groundplane and one surface of radiating elements of the street sign antenna of FIG. 2.

FIG. 4 is a side section view of the street sign antenna of FIG. 2.

FIG. 5 is a perspective view of an exemplary patch radiating element of the street sign antenna of FIG. 2.

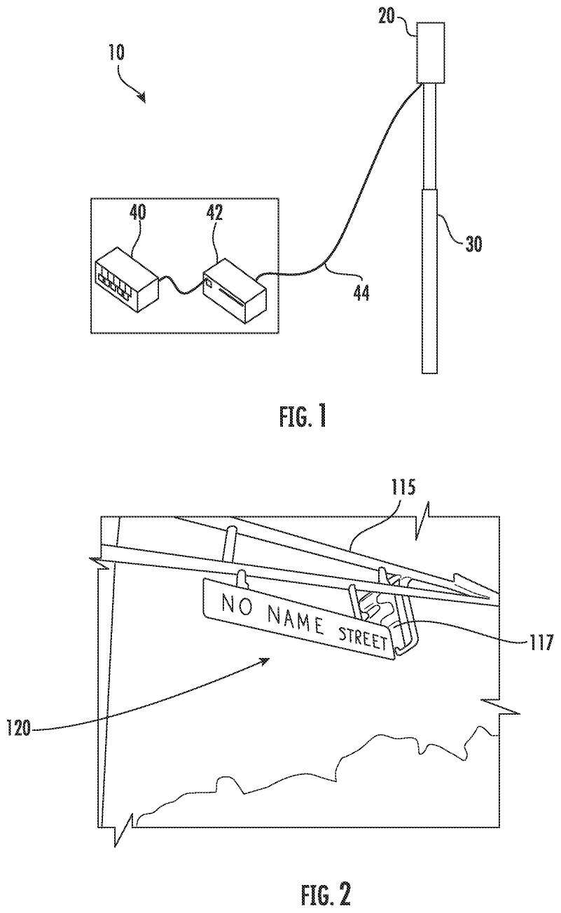

### DETAILED DESCRIPTION

Aspects of the present disclosure are described below with reference to the accompanying drawings. The present disclosure is not limited to the illustrated embodiments; rather, these embodiments are intended to fully and completely convey to those skilled in this art how to make and use the teachings of the present disclosure. In the drawings, like numbers refer to like elements throughout. Thicknesses and dimensions of some elements may not be to scale.

Spatially relative terms, such as “under”, “below”, “lower”, “over”, “upper”, “top”, “bottom” and the like, may be used herein for ease of description to describe one element or feature's relationship to another element(s) or feature(s) as illustrated in the figures. It will be understood that the spatially relative terms are intended to encompass different orientations of devices described herein in use or operation in addition to the orientation depicted in the figures. For example, if a device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity. As used herein the expression “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

Referring now to the figures, FIG. 2 illustrates a street sign antenna, designated broadly at 120, hanging from a street pole 115 along with a stoplight 117. The street sign antenna 120 is configured to function as both a street sign and as a small cell antenna. A typical street sign size has an area of about 30″×6″, which can allow for radiating elements in multiple bands that an operator can use, both licensed and unlicensed. The construction of the street sign antenna 120 is discussed in greater detail below.

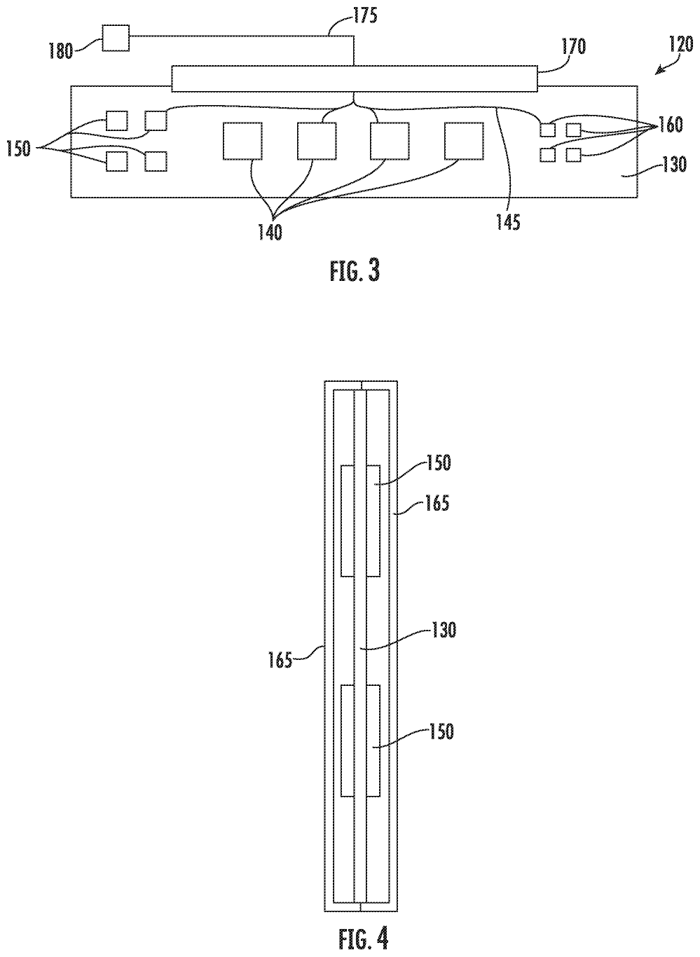

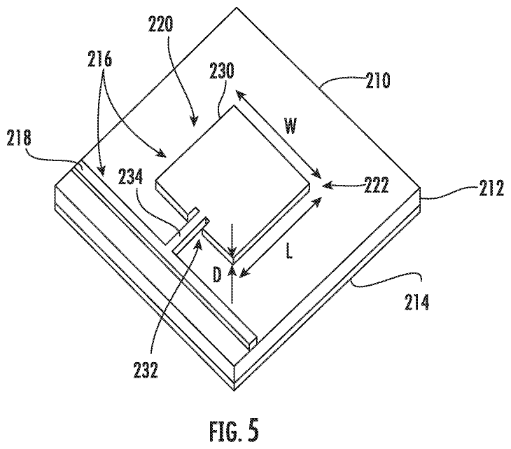

Referring now to FIGS. 3 and 4, the street sign antenna 120 includes a ground plane 130, arrays of radiating elements 140, 150, 160 on both sides of the ground plane 130, and radomes 165 that cover the radiating elements 140, 150, 160 on which lettering and the like can be printed. One side of the ground plane 130 is shown in FIG. 3. As can be seen therein, the ground plane 130 (which is formed of metal) provides a reflector on which arrays of radiating elements 140, 150, 160 are mounted. A feed network 145 connects the radiating elements 140, 150, 160 with a connectivity hub 170 that in turn is connected with cables 175 that carry signals to and from the street sign antenna 120 to a radio 180 and/or other equipment located remotely from the street sign antenna 120. Although FIG. 3 illustrates a hub 170 connected to all of the radiating elements 140, 150, 160, in some embodiments a separate transmission line may be included for each frequency band.

Although any suitable radiating element may be employed, in the illustrated embodiment the radiating elements 140, 150, 160 are microstrip patch antennas (shown in FIG. 3 as square patches). FIG. 5 is a perspective view of a conventional patch radiating element 220. As shown in FIG. 5, the conventional patch radiating element 220 is formed in a mounting substrate 210. The mounting substrate 210 comprises a dielectric substrate 212 having lower and upper major surfaces, a conductive ground plane 214 that is formed on the lower major surface of the dielectric substrate 212 and a conductive pattern 216 that is formed on the upper surface of the dielectric substrate 212 opposite the conductive ground plane 214. The patch radiating element 220 comprises a patch radiator 230 that is part of the conductive pattern 216, as well as the portion 222 of the dielectric substrate 212 that is below the patch radiator 230 and the portion of the conductive ground plane 214 that is below the patch radiator 230 (not visible in FIG. 5). A feed line 234 is coupled to the patch radiator 230. The feed line 234 may connect the patch radiating element 220 to a transmission line 218 such as, for example, a transmission line that is part of a feed network. The feed line 234 and the transmission line 218 are part of the conductive pattern 216 that is formed on the upper surface of the dielectric substrate 212.

Additional information regarding patch radiating elements is set forth in U.S. patent application Ser. No. 16/163,601, filed Oct. 18, 2018, the disclosure of which is hereby incorporated herein by reference in full. Other suitable radiating elements include, as examples, airstrip radiating elements and horn radiating elements.

Referring again to FIG. 3, in the illustrated example, the arrays of radiating elements 140, 150, 160 are configured to perform at different frequencies. For example, a mid-band 1.9 GHz set of radiating elements 140 can be arranged in the center of the ground plane 130, while to the sides there can be a set of radiating elements 150 for CBRS 3.5 GHz and a set of radiating elements 160 for LAA 5 GHz. The radiating elements 140, 150, 160 can be arranged in a mirrored fashion on the front and back sides of the groundplane 130 (see FIG. 4).

The street sign antenna 120 as illustrated would form “peanut-shaped” antenna patterns in the azimuth plane (oriented perpendicular to the sign) which would aim the antenna beams down the street in back and forth directions (e.g., to the north and to the south for a north-south roadway). Other pattern shapes may also be suitable for different coverage patterns.

The radomes 165 can be formed of any material and in any configuration known to be suitable for protecting radiating elements and permitting RF transmission therethrough. The radomes 165 may have lettering (such as the name of a street or roadway), or other indicia (such as a directional arrow or the like). In some embodiments, the “radome” may take the form of a film overlying the radiating elements 140, 150, 160 that may include silkscreening or other printed material thereon.

As illustrated in FIG. 3, the connectivity hub 170 may be located in a mounting bracket that attaches the street sign antenna 120 to a pole, post, or the like. The connectivity hub 170 may be galvanically or capacitively coupled with the antenna 120. Cables 175 may be routed from the antenna connectivity hub 170 to the radio 180 through channels in the mounting bracket to decrease visibility and/or provide protection for the cables 175 and connections. The antenna 120 and radio 180 thus serve as a small cell base station.

Those of skill in this art will appreciate that other types of signs may benefit from the inclusion of an antenna as described above. For example, other traffic signs that convey traffic information to motorists, such as stop, yield, speed limit, and directional signs may include an antenna.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. A small cell base station, comprising:
(a) an antenna comprising:
a ground plane;
a plurality of radiating elements mounted to the ground plane;
a feed network connected with the plurality of radiating elements: and
a cover that overlies the radiating elements, the cover including visual indicia that provides traffic information to motorists; and
(b) a radio connected with the feed network.

2. The small cell base station defined in claim 1, wherein the plurality of radiating elements comprises first and second subsets of radiating elements, the first subset having a different operating frequency from the second subset.

3. The small cell base station defined in claim 1 further comprising a street pole, the antenna being mounted on the street pole.

4. The small cell base station defined in claim 1, wherein the traffic information comprises information indicating the identity of a street.

5. The small cell base station defined in claim 1, wherein the plurality of radiating elements comprises patch radiating elements.

6. The small cell base station defined in claim 1, wherein the covers comprise radomes.

7. The small cell base station defined in claim 1, wherein the ground plane includes opposed front and rear surfaces, and wherein the plurality of radiating elements are mounted on both the front surface and the rear surface.

8. The small cell base station defined in claim 7, wherein the plurality of radiating elements are configured to create a peanut-shaped antenna beam having lobes extending in opposing directions that are normal to the front and rear surfaces of the ground plane.

9. A small cell antenna, comprising:
a ground plane;
a plurality of radiating elements mounted to the ground plane;
a feed network connected with the plurality of radiating elements; and
a cover that overlies the radiating elements, the cover including visual indicia that provides traffic information to motorists.

10. The small cell antenna defined in claim 9, wherein the plurality of radiating elements comprises first and second subsets of radiating elements, the first subset having a different operating frequency from the second subset.

11. The small cell antenna defined in claim 9, further comprising a street pole, the antenna being mounted on the street pole.

12. The small cell antenna defined in claim 9, wherein the traffic information comprises information indicating the identity of a street.

13. The small cell antenna defined in claim 9, wherein the plurality of radiating elements comprises patch radiating elements.

14. The small cell antenna defined in claim 9, wherein the covers comprise radomes.

15. The small cell antenna defined in claim 9, wherein the ground plane includes opposed front and rear surfaces, and wherein the plurality of radiating elements are mounted on both the front surface and the rear surface.

16. The small cell antenna defined in claim 15, wherein the plurality of radiating elements are configured to create a peanut-shaped antenna beam having lobes extending in opposing directions that are normal to the front and rear surfaces of the ground plane.

17. A small cell antenna, comprising:
a ground plane having opposed front arid rear surfaces;
first and second pluralities of radiating elements mounted to the ground plane, the first plurality of radiating elements having a different operating frequency from the second plurality of radiating elements;
a feed network connected with the pluralities of radiating elements; and
a cover that overlies the radiating elements, the cover including visual indicia that provides traffic information to motorists;
wherein some of the first plurality of radiating elements are mounted on the front surface of the ground plane, and the remaining radiating, elements of the first plurality are mounted on the rear surface of the ground plane; and
wherein some of the second plurality of radiating elements are mounted on the front surface of the ground plane, and the remaining radiating elements of the second plurality are mounted on the rear surface of the ground plane.

18. The small cell antenna defined in claim 17, wherein the first and second pluralities of radiating elements comprise patch radiating elements, and wherein the cover comprises a radome.

19. (canceled)

20. A small cell antenna, comprising:
a ground plane;
a plurality of radiating elements that form part of the ground plane;
a feed network connected with the plurality of radiating elements; and
a cover that overlies the radiating elements, the cover including visual indicia that provides traffic information to motorists.

21. The small cell antenna defined in claim 20, wherein the radiating elements are slot-type radiating elements.
